(19) United States
(12) Patent Application Publication
(10) Pub. No.: US 2026/0093386 A1
(43) Pub. Date: Apr. 2, 2026

(54) CONTENT INSERT USER INTERFACE

(71) Applicant: GOOGLE LLC, Mountain View, CA (US)

(72) Inventors: Donny Chen Reynolds, Mountain View, CA (US); Yuncheng Shen, Sunnyvale, CA (US); Matthieu Trudeau, Seattle, WA (US); Sarah Chou, San Francisco, CA (US); Ryosuke Matsumoto, Dublin, CA (US)

(21) Appl. No.: 18/902,684

(22) Filed: Sep. 30, 2024

(51) Int. Cl. G06F 3/0484; G06F 3/0482; G06F 16/14

(52) U.S. Cl. CPC G06F 3/0484; G06F 3/0482; G06F 16/148

(57) ABSTRACT

A method may determine that a predetermined input gesture has been detected when an input area in an application has focus. A method may in response to determining that the predetermined input gesture has been detected when the input area has focus, initiating a display of a user interface including. A method may display a first selectable option configured to insert content related to a file into the input area in response to selection. A method may display a second selectable option configured to, in response to selection, perform a default operation of the predetermined input gesture.

### BACKGROUND

Presently, users can insert content into a first application using a cut-and-paste or copy-and-paste operation. Such operations may use a clipboard to temporarily store the content.

### SUMMARY

Methods describe triggering the display of a user interface and using the user interface to select content for insertion directly into an application. Upon determining that a dual-purpose predetermined input gesture has been detected (e.g., actuating a button on a keyboard) that is associated with inserting content while an input area of an application has focus, the user interface is displayed with one or more selectable options that may be used to insert content. In response to selection, a first selectable option may be configured to insert content related to a file into the input area, and a second selectable option may be configured to perform a default operation associated with the predetermined input gesture.

The user interface may include a selectable option configured to insert content relating to a recently accessed file into an input area of the application. In examples, the file may be identified using context from the application or a query from the user. In examples, the user interface may include a query field that may be further accessed by the user to search for files or generate content.

Methods describe a user interface with at least two selectable options. The first selectable option may be used to insert content related to a file accessed within a time threshold, and the second option may be used to insert content generated by a model into an input area of an application.

In some aspects, the techniques described herein relate to a method including: determining that a predetermined input gesture has been detected when an input area in an application has focus; and in response to determining that the predetermined input gesture has been detected when the input area has focus, initiating a display of a user interface including: a first selectable option configured to insert content related to a file into the input area in response to selection, and a second selectable option configured to, in response to selection, perform a default operation of the predetermined input gesture.

In some aspects, the techniques described herein relate to a system including: a processor; and a memory configured to: detect a predetermined input gesture; in response to detecting the predetermined input gesture, determining whether an input area in an application has focus; in response to determining that an input area in an application has focus, initiating a display of a user interface including a first selectable option configured to insert content into the input area in response to selection, and in response to determining that an input area in an application lacks focus, perform a default operation of the predetermined input gesture.

In some aspects, the techniques described herein relate to a method including: receiving an input entered in a user interface; in response to receiving the input, initiating display of: a first selectable option in the user interface configured to, in response to selection, insert first content related to a file accessed by a user within a time threshold into an input area of an application, and a second selectable option in the user interface to insert second content generated by a model into the input area; in response to determining that the first selectable option has been selected, inserting the first content into the input area; and in response to determining that the second selectable option has been selected, inserting the second content into the input area.

### BRIEF DESCRIPTION OF THE DRAWINGS

FIG. 1 depicts an application, according to examples described throughout this disclosure.

FIG. 2 depicts a partial example keyboard, according to examples described throughout this disclosure.

FIG. 3 depicts an example application, according to examples described throughout this disclosure.

FIG. 4 depicts an example application, according to examples described throughout this disclosure.

FIG. 5 depicts an example application, according to examples described throughout this disclosure.

FIG. 6 depicts an example application, according to examples described throughout this disclosure.

FIG. 7 depicts an example application, according to examples described throughout this disclosure.

FIG. 8 depicts an example application, according to examples described throughout this disclosure.

FIG. 9 depicts an example application, according to examples described throughout this disclosure.

FIG. 10 depicts an example user interface, according to examples described throughout this disclosure.

FIG. 11 depicts an example user interface, according to examples described throughout this disclosure.

FIG. 12 depicts an example user interface, according to examples described throughout this disclosure.

FIG. 13 depicts an example method, according to examples described throughout this disclosure.

FIG. 14 depicts an example method, according to examples described throughout this disclosure.

FIG. 15 depicts an example system, according to examples described throughout this disclosure.

### DETAILED DESCRIPTION

The disclosure describes a user interface that may provide a multi-source input interface for a user who wishes to insert content into an input area of an application without having to take the application out of focus or needing to use an additional application to find, identify, or copy the file. In some examples, the display of the user interface may be triggered with a predetermined input gesture (e.g., a keyboard key). In some examples, the user interface may allow a user to both search for a file and generate content to insert into the application from a single query field.

It is a technical problem that, when a user wishes to find and insert recently accessed content into an input area in a first application, users often must navigate away from the first application to a second application to locate the content that they want to insert. Once content in the second application is identified (usually manually), that content must be copied-and-pasted or dragged-and-dropped back to the input area in the first application. This can include navigating away from the second application back to the first application. Such context switching between windows and manually locating the content causes user friction and may be particularly problematic for users having reduced dexterity and/or manual capabilities, which can make effective interaction with their device more difficult. In addition, such context switching uses additional processor cycles and operating system resources and takes up space on a display. The process takes time, and moving away from the primary application to identify and retrieve content can create distractions for a user. A user often must clean up again after, for example by closing browser tabs or applications accessed to find the content.

One technical solution proposed in the disclosure is a user interface that may be triggered via the operating system when an input area in an application has focus and a predetermined input gesture has been detected. An input gesture may include any user-initiated actuation of an input device or peripheral in communication with a user device. In examples, an input device may include a physical keyboard key, a virtual keyboard key, a mouse button, a headset button, a motion detector or a camera that can capture hand gestures (for example on an augmented reality headset device), a joystick, a trackball, and so forth. In examples, the gesture may include a tap gesture, a long press gesture, a stylus gesture, a hand gesture, and so forth. The input device may be actuated (e.g., pressed, selected, moved, invoked, or otherwise sensed) to provide a predetermined input gesture.

In some examples, the input gesture may be associated with the user interface as a dual-function input gesture. More specifically, the dual function input gesture may be used to trigger the display of the user interface if an input area has focus or configured to perform another default operation in response to actuation if an input area lacks focus (i.e., does not have focus). Using the example of a keyboard caps-lock key, the key may be used to either trigger the display of the user interface or toggle the caps-lock function of the keyboard. In some examples, the predetermined gesture may be a dedicated gesture. Put another way, in such examples the predetermined gesture may be always associated with the user interface and configured to always trigger the display of the user interface when detected. In some examples, the user interface may be triggered in other ways, such as by a combination of gestures, a menu option, etc. The user interface provides a multi-source input interface that may be populated with recently accessed content that can be inserted into the application without opening or giving focus to additional applications (e.g., the applications associated with the sources/recently accessed content).

A further technical solution proposed in the disclosure allows users to identify content from files and/or generate content via the same user interface, which can be provided by the operating system. The user interface allows a user to identify information from multiple sources to insert in a single input area without a need to switch away to other applications. In some examples, the sources can include files recently opened or accessed by the user. In some examples, the sources can include generated content. In some examples, the sources can include the output of applications that take input of a particular format, e.g., applications that perform a particular operation or conversion of the input. In some examples, the sources can be an application that performs a specific function, such as providing a weather forecast, a game-day schedule, etc.

The technology described herein can enable a user to interact with their device more efficiently, for instance by enabling them to input data more efficiently. As mentioned above, this may be particularly useful for users having reduced dexterity and manual capabilities, which can make effective interaction with their device problematic. For instance, the technology described herein may reduce the need for users to switch between applications in order to locate, and manually copy, information for use in another application. In addition, the user interfaces described provide an improved guided human-machine interaction process to insert previously unselected content from other applications straight into an input area of an application without needing to navigate away from the input area in the application. Because the methods described use fewer user inputs, windows, threads, processes, and window focus changes, they reduce the use of processing resources on device and the number of interactions with the device to complete the task of adding content from another application to an input area in the current application. The user interfaces described herein may also allow a user to operate with fewer windows open on a desktop, using less desktop space, thereby reducing friction. In examples where the display of the user interface may be triggered by a predetermined gesture, such as keyboard key, using the user interface to insert information may reduce the number of times that a user must go between input devices, such as the keyboard and a mouse.

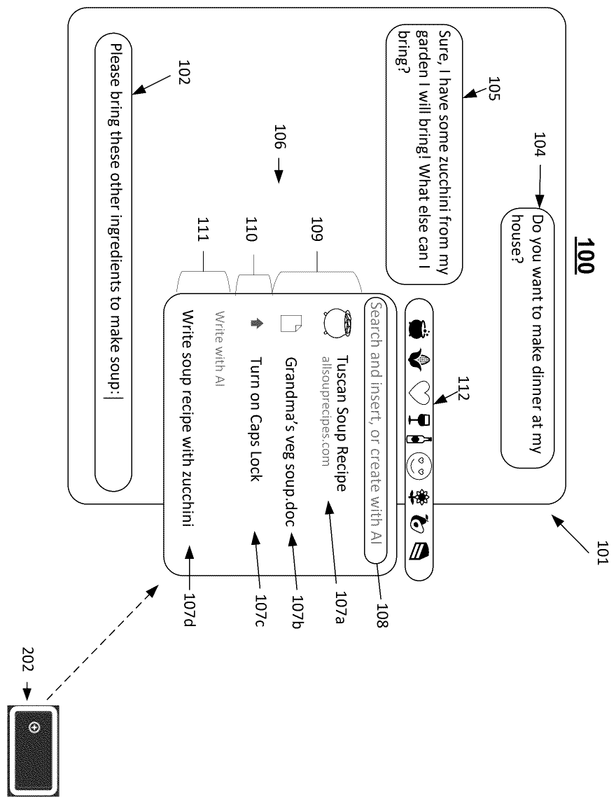

FIGS. 1-12 depict an example use cases 100-1200, according to examples. In the example use cases 100-900, the application 101 depicted is a chat application for ease of discussion and illustration, but implementations are not limited to a particular application. Any application into which content may be inserted is contemplated. Application 101 may be any application that allows a user to create, access, edit, save, or send content, for example: word processing, social media, illustrator, image or video editor, a spreadsheet, or email applications, in addition to others. Use cases 1000-1200 depict various views of the user interface, illustrating different selectable options that can be triggered to insert content into the input area of the application 101.

Application 101 includes an input area 102. An input area is a space in an application where content can be interacted via adding, editing, deleting activities. In examples, input area 102 may accept any combination of text (including rich text), image, hyperlink, and/or video. Example input area 102 of application 101 allows a user to send a message to another user, but in further examples input area 102 may allow a user to create a social media post, edit a document, provide a field value to a form, or to otherwise access, edit, or save content.

In FIG. 1, use case 100 is depicted. A device user executing application 101 has sent a message 104, “Do you want to make dinner at my house?” A second user has replied “Sure, I have some zucchini from my garden I will bring! What else can I bring?” and that message 105 has been received at application 101. In input area 102, a user has begun to provide a reply, “Please bring these other ingredients to make soup:”

FIG. 1 depicts a user interface 106. In examples, user interface 106 may be used to identify and/or generate content and insert that content into input area 102. In examples, user interface 106 may be controlled by an operating system. With user permission, user interface 106 may allow a user the ability to access content across applications and/or file directories without moving focus away from application 101. In examples, an input area of the application 101 has focus when the cursor is within a text area of the application 101. Put another way, an input area of the application 101 has focus when input (text entered, click input, touch input, etc.) passed from the operating system to the application 101 will be entered into the input area.

In examples, user interface 106 may appear over and/or beside application 101. In examples, user interface 106 may remain on top. In other words, user interface elements of application 101 may not cover any portion of user interface 106.

In examples, components of application 101 may further have focus within application 101. For example, when a cursor is inside input area 102, input area 102 may have focus.

In examples, the display of user interface 106 may be triggered via a variety of user actions. In examples, the display of user interface 106 may be triggered by right clicking, for example over input area 102, via a control on a task bar, via the start menu, via an application menu, or via any other method. While the example of triggering the display of user interface 106 by actuating a keyboard key is discussed throughout the rest of this disclosure, this is not intended to be limiting. In examples, other user input gestures may be used to trigger the display of user interface 106.

FIG. 2 depicts a partial view of a keyboard 200, according to an example. In examples, keyboard 200 may comprise any standard or custom keyboard. Keyboard 200 includes a keyboard key 202 which, when actuated (e.g., pressed/selected) by a user, may initiate the display of user interface 106. In examples, the display of user interface 106 may be triggered while input area 102 has focus and keyboard key 202 is actuated. In some examples, the keyboard key 202 may be a dual-function key. In the example of keyboard 200, keyboard key 202 is located at the position of a standard caps lock (i.e., capitals lock) key and is a dual-function key. In examples, the dual-function keyboard key 202 may be associated with a default operation (e.g., caps lock, volume, insert, etc.) that is performed when no input area has focus. In the example of keyboard 200, if no input area has focus, actuating the keyboard key 202 toggles the caps-lock setting (e.g., toggle from caps-lock on to caps-lock off to caps-lock on, etc.). However, if an input area, such as input area 102, has focus the dual-function key initiates display of the user interface 106 upon actuation. In further examples, keyboard key 202 may take any key position on keyboard 200, however, and have a different default action.

User interface 106 may include one or more components. For example, user interface 106 may include a query field 108 operable to receive an input (e.g., a query) to identify/find a file or generate content from the device user. User interface 106 may include a file suggestion section 109 operable to allow a user to insert files or content from files into input area 102. User interface 106 may include a dual-function setting section 110, operable to allow a user to access dual-function key capabilities. User interface 106 may include a generative content section 111 operable to allow a user to generate content to insert into input area 102. User interface 106 may further include an emoji section 112 operable to help a user quickly select a relevant emoji for insertion into input area 102. In examples user interface 106 may include any combination of these sections, in addition to other sections. For example, user interface 106 may include a user information browsing section operable to allow the user to explore their browser history or open browser tabs.

In examples where user interface 106 includes file suggestion section 109, the file suggestion section 109 may include one or more selectable options. A selectable option may be configured to insert content related to a file into input area 102. The selectable option may include text that identifies the file. In examples, the file may include any type of file saved in a directory internal to the device memory or available via a network, such as the Internet. A file can include a web page, an image file, a video file, a text file, a document file, a spreadsheet, a presentation, an executable file, etc., or any combination thereof.

In examples, the file may have been recently accessed by the user within a recency threshold (e.g., a time threshold or time horizon). The recency threshold may be set by the operating system and can represent a time period such as, for example a week, two weeks, or a month. In the example of FIG. 1, the file suggestion section 109 includes two selectable options, a file option 107a and a file option 107b. File option 107a relates to a Tuscan soup recipe URL recently viewed by the user. In examples, with user permission, the resource locator associated with file option 107a may be identified, for example from a browser history associated with a web browser application. In examples, the browser history may include resource locators of files visited, the time and date of the visit, query terms used to navigate to the file, etc.

In examples, file suggestion section 109 may include any number of selectable options related to files. For example, in FIG. 1 file suggestion section 109 includes a file option 107b, which is related to another file, “Grandma's veg soup.doc”, which may be a file saved on the device executing application 101.

Upon selection of any selectable option from file suggestion section 109, a reference to the file associated with the selectable option, such as a link to the file, or the resource locator associated with the file, may be inserted into input area 102. In further examples, however, a selection of a selectable option may initiate the display of further selectable options of the same category or may allow a user to enter a prompt relating to the file, as is further described below.

In examples, file option 107a and file option 107b may be identified based on context from application 101. In examples, user interface 106 may initiate a search for one or more files related to terms and/or phrases included in any combination of input area 102, message 104, and/or message 105. For example, input area 102 includes the term, ‘soup’ and message 105 includes the term, ‘zucchini’. How context from application 101 may be used to generate selectable options is further discussed below. In examples and with user permission, further context from application 101 may be used to help identify selectable options within file suggestion section 109, such as (but not limited to) time of day, season, the type of application, or information relating to the second user.

In examples, with user permission, context may be identified from application 101 and used as an input into the machine learning model to identify what files are associated with content a user may wish to provide for usable selection into input area 102. A training set of data may be used to train the machine learning model that includes content that is pasted into applications along with time-correlated context from application 101. For example, the training set of data may include content pasted into one or more applications correlated with context from application 101 for some predetermined amount of time.

In examples, file option 107a may be the first selectable option positioned near the top of user interface 106. In examples, file option 107a may be selected by simply selecting the ENTER key after file suggestion section 109 is displayed.

User interface 106 may include a query field 108. Query field 108 may be used to initiate a search for content and/or to generate content using a generative model to insert into input area 102. In examples, if the first user is not satisfied with the initial selectable options offered in user interface 106, the user may identify and/or generate others using user interface 106.

In examples, query field 108 may get focus when user interface 106 is initially displayed. This may allow the user to go straight from typing a message to searching for content or generating content to insert without moving hands away from a keyboard.

In examples, query field 108 may be displayed with a message explaining to the user how query field 108 may be utilized. In the example, query field 108 is displayed initially with the text “Search and insert, or create with AI”. The text initially is grayed and may disappear when the cursor is inserted into query field 108 to distinguish it from text that a user later enters there.

In examples where keyboard key 202 is used to trigger the display of user interface 106, it may be difficult to identify a space on a standard keyboard for an additional key dedicated to this new functionality. In such situations an existing key on the keyboard may be selected and used as a dual function key. The default operation for the existing key, e.g., key 202, may be one of the selectable options in a keyboard setting section 110. The selectable option may be referred to as a default operation option 107c. Dual-function setting section 110 may allow a user to access the functions that keyboard key 202 would have under a standard keyboard layout, i.e., without the dual function. In the example of FIG. 2, keyboard key 202 is in the position of a caps lock key. Therefore, dual-function setting section 110 includes a default operation option 107c, which, upon selection, will toggle the caps lock setting on/off. In examples, dual-function setting section 110 may allow access to other standard keyboard functions associated with other keyboard keys.

In examples, user interface 106 may include generative content section 111. Generative content section 111 may allow a user to generate content using a generative model (e.g., a large language model). A generative language model is a type of machine-learning model that uses deep learning to generate a response based on a prompt and a context. Language models are trained on vast amounts of data, typically in the form of text or speech, and can be configured (trained) to use this data to predict entities and/or entity types associated with webpages. Using prompts and context as inputs, language models generate outputs or responses. A prompt is an input to which the language model generates a response. Prompts can include instructions, questions, or any other type of input, depending on the intended use of the model. In examples, the generative content section 111 may include one or more suggested prompts as selectable options. In the example of FIG. 1, the generative content section 111 includes suggested prompt option 107d. In examples, suggested prompt option 107d may be generated using context from application 101. In the example of FIG. 1, suggested prompt option 107d suggests, “Write a soup recipe with zucchini.” This prompt may have been generated based on context from message 105, for example, which says, “I have some zucchini.” More about suggesting prompts is discussed below.

In examples, user interface 106 may further include emoji section 112. Emoji section 112 may be used to suggest emoji for selection and insertion into input area 102. In examples, the emoji displayed in emoji section 112 may be selected for display based on how recently the user accessed them. In examples, the emoji displayed in emoji section 112 may be identified based on context from application 101. For example, the first user in FIG. 1 has typed “Please bring these other ingredients to make soup:”. In the example of FIG. 1, emoji section 112 displays emoji related to ‘ingredients’ and ‘soup’, such as a soup pot and vegetables. In response to message 105, “What else can I bring?”, items typically brought by guests to a potluck dinner are depicted in emoji section 112, such as a wine bottle and desert (a slice of cake). More about suggesting emoji is discussed below. In examples, an emoji within emoji section 112 may be inserted into input area 102 upon selection. In examples, clicking on any portion of emoji section 112 without an emoji may bring up a larger selection of emoji for a user to select from.

In examples, a user may enter text into query field 108 to initiate a search for content to insert. In examples, terms from the text may be matched to terms in the title and/or metadata of files to identify files to provide in file suggestion section 109. In examples, an index may be searched to identify URLs related to one or more search terms. In examples, an embedding may be generated from the text entered into query field 108 using a generative model. The embedding may then be compared to a data store of file embeddings to identify files with content that are closest in meaning to the text. In examples where more than one file is identified, a determination of intent may be used to further identify which of the identified files may be associated with relevant content. In examples, a knowledge graph, a machine learning model, or keyword matching may be used to determine intent. In examples, the text entered into the query field 108 may be compared to one or more triggers for short-answer providers. Finally, the identified content (e.g., files and/or short answers) may be ranked for display within file suggestion section 109. For example, the content may be ranked according to type or recency of access or relevance to the query and/or the application context.

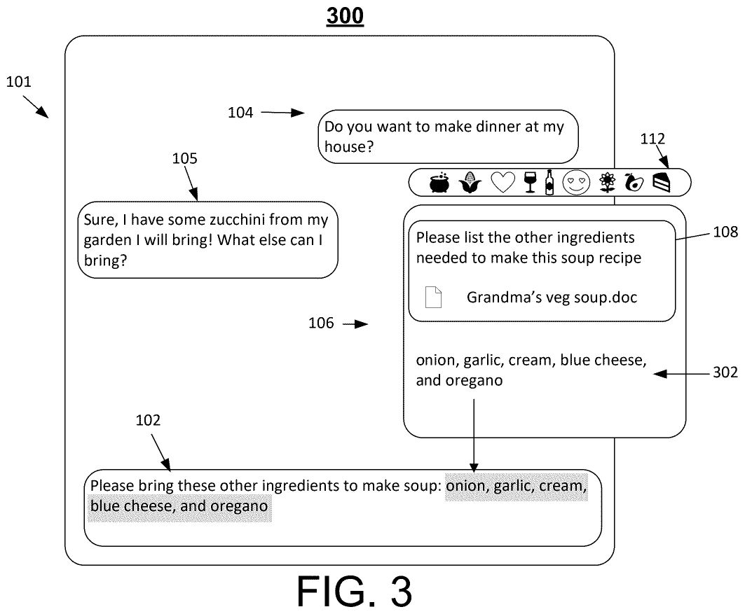

FIG. 3 depicts use case 300, in accordance with an example. In use case 300, a user enters a prompt to generate content. The first user has selected file option 107b of FIG. 1 and entered text into query field 108, “Please list the other ingredients needed to make this soup recipe”. The recipe file, “Grandma's veg soup.doc” is identified.

Upon receiving the text in query field 108 or upon receiving an indication that a user pressed a key that indicates selection of the control, for example the ENTER key, user interface 106 may initiate the generation and display of a result 302. In examples, the generative model may be provided with a resource locator of the recipe file or the content of the file, and context from the application (e.g., message 104, message 105 and the text entered in input area 102) as prompt context and generate the result 302. The generative model may determine that “other ingredients” in the text may mean ingredients besides those described in message 105 (“zucchini”).

In further examples, however, a machine learning model using the text entered into query field 108 and message 105 as inputs may determine that the user has the intent of extracting an ingredients list from a recipe file that does not include the term, “zucchini”. In examples, a prompt may be generated, “please provide a list of ingredients from this text that does not include ‘zucchini’” for use with the content of “Grandma's veg soup.doc” as inputs to a generative model, which may generate a list of ingredients as a result.

In FIG. 3, it may be seen that result 302 includes the list of soup ingredients, “onion, garlic, cream, blue cheese, and oregano.” The result 302 may be a selectable control, e.g., a control that performs an action upon selection. The action may be to insert the result 302 into input area 102.

In examples, a generative model may be used to produce other content based on a file identified. For example, a user may enter text into input area 102 to request an option to insert a summary, an outline, or a list of the key points of a file, such as the recipe file “Grandma's veg soup.doc”.

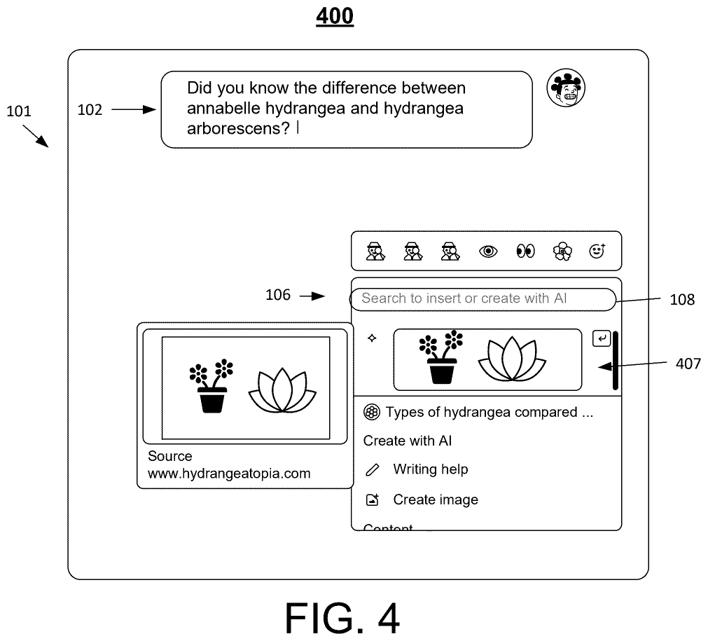

FIGS. 4-8 illustrate further potential features of user interface 106. For example, FIG. 4 depicts use case 400, according to an example. In input area 102, the device user has typed, “Did you know the difference between annabelle hydrangea and hydrangea arborescens?” With the cursor still in input area 102, the device user triggers display of user interface 106 (for example, by pressing keyboard key 202). In examples, user interface 106 may initiate a search for content relevant to context from application 101 for insertion into input area 102.

For example, based on the context of the question typed into input area 102, user interface 106 may initiate a search for content from a file related to annabelle hydrangea and hydrangea arborescens. In examples, a search of a browser history may determine that the device user recently visited www.hydrangeatopia.com to view a page titled, “Types of hydrangea compared.” User interface 106 may display a selectable option 407 in response. In examples, selectable option 407 may be operable to insert the URL into input area 102. In examples, selectable option 407 may be operable to insert a screenshot of an image from the URL including both annabelle hydrangea and hydrangea arborescens into input area 102. In examples, user interface 106 may display both potential selectable options for the user or find other information relating to annabelle hydrangea and hydrangea arborescens to incorporate into selectable options.

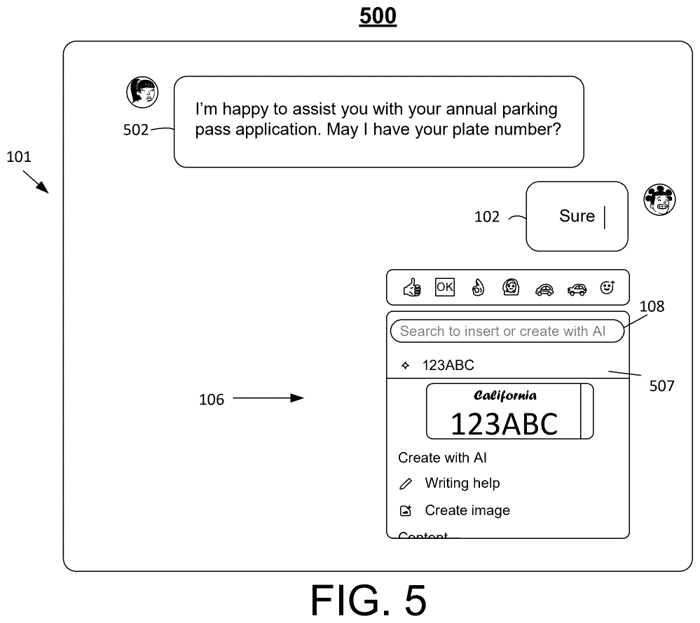

FIG. 5 depicts a use case 500, according to an example. In this example, the device user is asked via a message 502, “May I have your plate number?” The device user replies in input area 102 in the affirmative, “Sure”, and triggers the display of user interface 106. User interface 106 may initiate an evaluation of the context of message 502 and input area 102 and initiate a search for a file including content relevant to car license plate numbers. In examples, an image with a California license plate may be identified. In response to identifying the image with the license plate, the number from the license plate may be further identified (for example, by applying OCR to the image). In examples, a selectable option 507 may be displayed within user interface 106, providing the option to insert the image of the license plate or the number identified from the license plate into the input area 102. In the example, selectable option 507 displays the image from which the license plate number was determined and provides the option to insert the text of the license plate number, “123ABC” into input area 102.

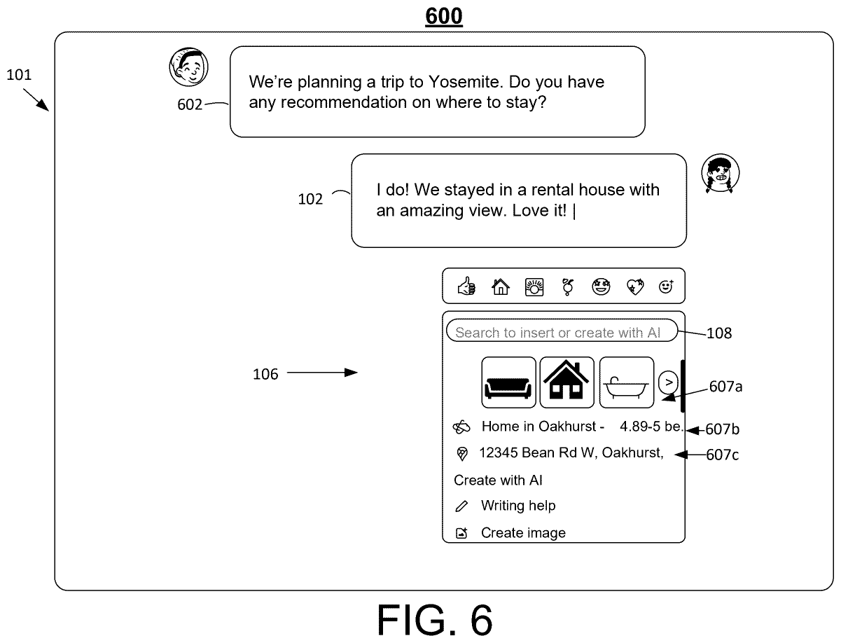

FIG. 6 depicts a use case 600, according to an example. In the example, a device user is asked in a message 602, “We're planning a trip to Yosemite. Do you have any recommendation on where to stay?” In response, the device user replies in input area 102, “I do! We stayed in a rental house with an amazing view. Love it!” before triggering the display of user interface 106. User interface 106 may initiate a search for content relevant to context from application 101 to insert into input area 102. Based on the context, “Yosemite” and “we stayed in a rental house”, user interface 106 may initiate a search for related content. With user permission, the data searched may include user information stored on the device or on the cloud. For example, the data searched may reference pins dropped, addresses from calendar events, browser history, and photos.

In the example, user interface 106 may display three selectable options. A first selectable option 607a may include one or more stored on a device of a property near to Yosemite. In examples, the one or more photos may be identified based on a location tag within a predetermined radius of Yosemite. In examples, the photos may be selected individually for insertion into input area 102.

A second selectable option 607b may provide a URL for a house near Yosemite from a website provider that rents vacation homes. In examples, the URL may be identified from a browser history. A third selectable option 607c may provide a location for a house near Yosemite. In examples, the location identified in 607c may be determined based on a reference pin from a map application.

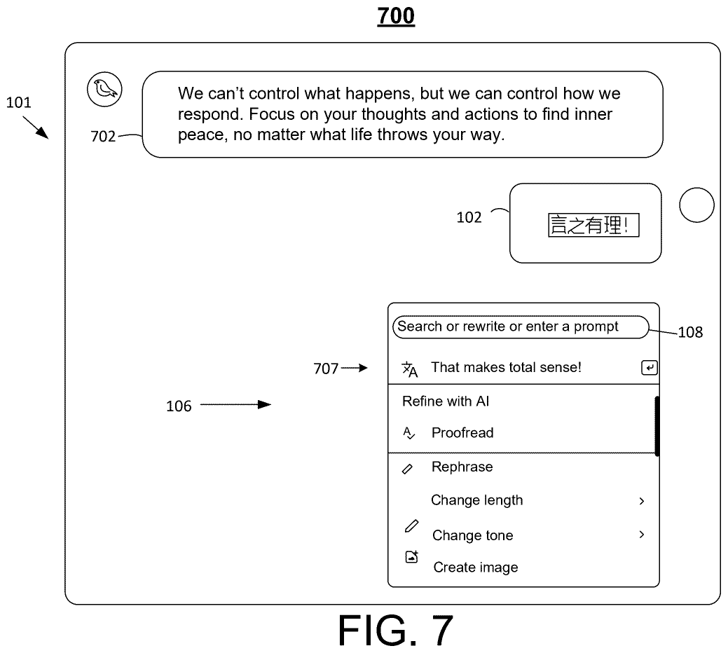

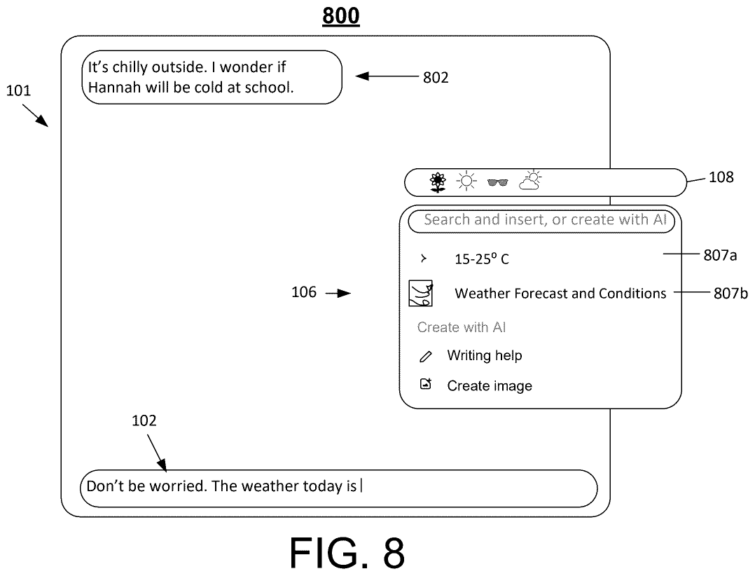

FIG. 7 depicts a use case 700, according to an example. In this example, a device user receives a message 702 with advice, “We can't control what happens, but we can control how we respond . . . ” The device user responds by typing Chinese characters in input area 102. Upon launching user interface 106, the context of message 702 and input area 102 are evaluated to provide a selectable option for content to insert. Upon determining that the text of message 702 is in English the text in input area 102 is in Chinese, user interface 106 may display a selectable control 707 with a translation of the Chinese characters from input area 102 into English to match the language used previously in the conversation. As may be seen in FIG. 7, selecting the selectable control 707 may result in inserting the text, “That makes total sense!” into input area 102.

FIG. 8 depicts a use case 800, according to an example. In this example, the device user receives a message 802, “It's chilly outside. I wonder if Hannah will be cold at school.” The device user begins a reply in input area 102, “Don't be worried. The weather today is” and triggers the display of user interface 106. User interface 106 may evaluate the context of message 802 and input area 102 and determine that the device user intends to describe the temperature for the day. With user permission, the current location of the device or a device user's address may be used to provide a weather report. In the example, user interface 106 may display a selectable control 807a providing text describing a temperature range for the day, “15-25° C.”. In examples, the text associated with selectable control 807a may be generated by determining an intent for the user's statement in input area 102 and performing a query to determine the weather forecast for the day. Upon selection, the text may be inserted into input area 102.

In examples, user interface 106 may further include a URL selectable control 807b, which may be configured to insert a URL into input area 102. In examples, the URL associated with URL selectable control 807b may be any combination of recently accessed and/or related to content found in message 802 and/or input area 102. For example, the URL associated with URL selectable control 807b in the example is a weather forecast URL.

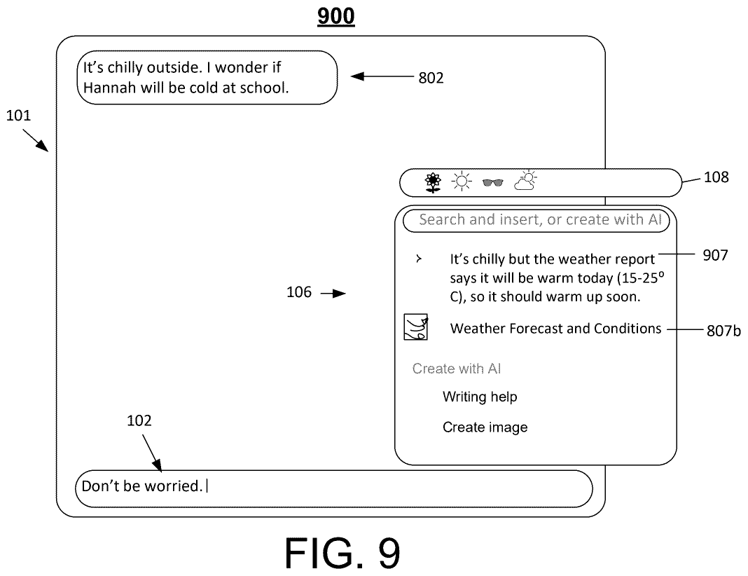

FIG. 9 depicts a use case 900, according to examples. In this example, the device user also receives message 802, “It's chilly outside. I wonder if Hannah will be cold at school.” The device user types a shorter reply in input area 102, “Don't be worried.” In response to triggering user interface 106, it may be determined that the device user wants to insert a reassuring response with some weather information. User interface 106 may therefore display a selectable control 907 operable to insert a statement into input area 102 to complete the device user's response, “It's chilly but the weather report says it will be warm today (15-25° C.), so it should warm up soon.” In examples, the statement that selectable control 907 is operable to insert may be generated using a combination of generated content using a model and a query for weather data.

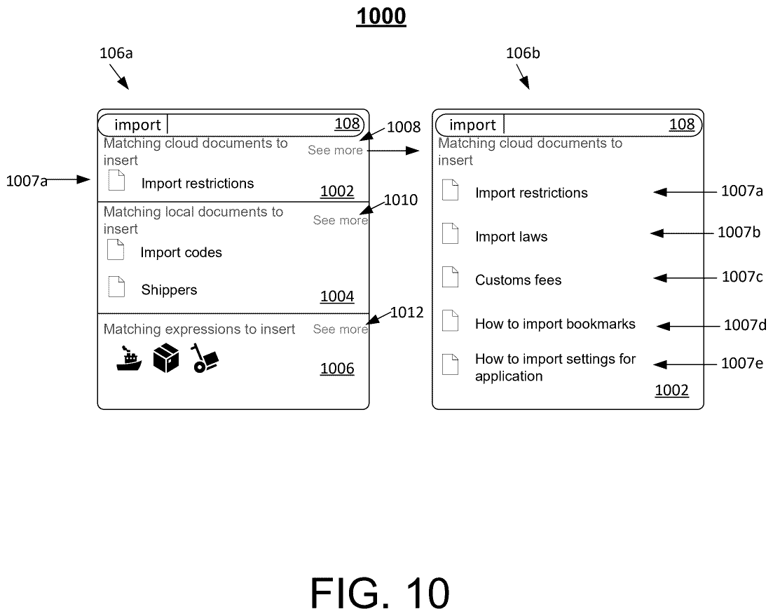

FIG. 10 depicts use case 1000, according to an example. FIG. 10 depicts sequential displays of user interface 106, labeled 106a and 106b with an arrow between. The display of user interface 106a may be triggered by a user. In the example of FIG. 10, the user has typed “import” into query field 108, and user interface 106 has displayed three sections specific to a type of file and/or content: a cloud document section 1002 (which includes a File option 1007a), a local document section 1004, and a matching expression section 1006. This is not intended to be limiting, however. In examples any number of sections may be displayed in user interface 106. In examples, cloud document section 1002, local document section 1004, and matching expression section 1006 may be displayed based on any combination of context from application 101 and query field 108.

In examples, cloud document section 1002, local document section 1004, and matching expression section 1006 may each include a respective selectable control operable to display more selectable options associated with the category relating to the files and/or content associated with the section. In examples, a category may include a file type (for example an image file or a PDF), a file storage location (for example cloud or local), files associated with a term (for example, a filename or metadata), or any other way that a file may be categorized. For example, cloud document section 1002 may include a section expansion control 1008, local document section 1004 may include a section expansion control 1010, and matching expression section 1006 may include a section expansion control 1012. Each section expansion control 1008, 1010, and 1012 may be configured as a link with the text, “see more” in the example. When any of section expansion control 1008, 1010, or 1012 are selected, the section they are associated with may be expanded to display additional selectable controls operable to insert content from the same types of files. In further examples, user interface 106a may lack any combination of section expansion control 1008, 1010, and 1012 and a category may be selected by selecting selectable options within any of cloud document sections 1002, 1004, and 1006.

In the example of use case 1000, a device user selects section expansion control 1008, and cloud document section 1002 appears to be expanded in the sequential display of user interface 106b. File option 1007a is displayed again, along with newly displayed file options 1007b-1007e. Each of file options 1007a-1007e inserts a link to and/or content from to a cloud document into input area 102. In the example, each of the documents associated with a respective file option 1007a-1007e is included in the cloud document section 1002 because it is related to the term, “import”.

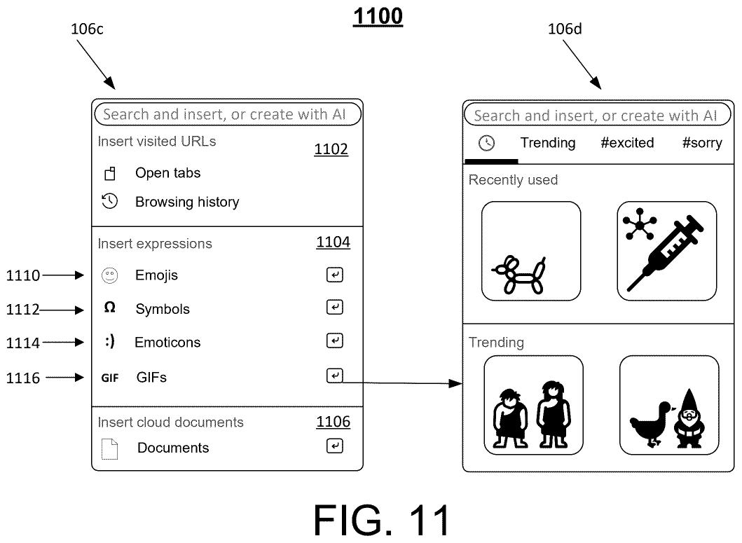

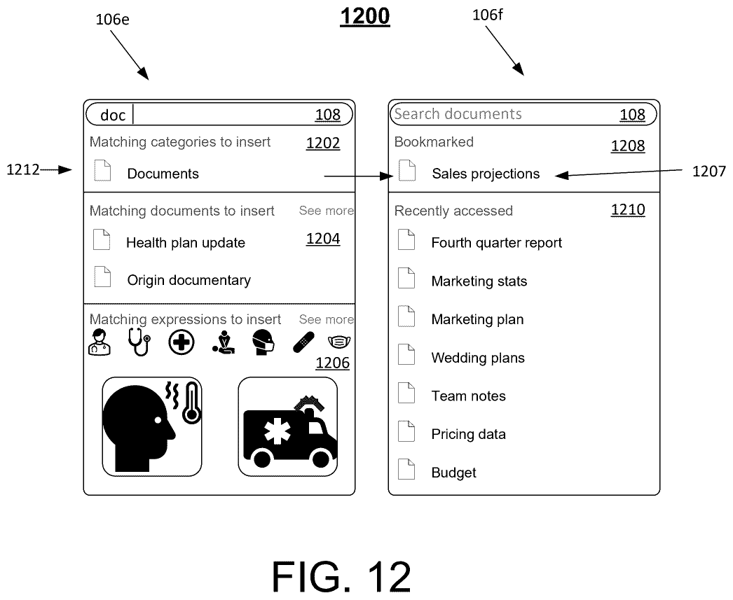

FIG. 11 depicts a use case 1100, according to examples. FIG. 11 depicts sequential displays of user interface 106, labeled 106c and 106d with an arrow between. User interface 106c includes file and content categories: a URL section 1102, an expression section 1104, and a cloud document section 1106. Each section 1102, 1104, and 1106 includes selectable controls for categories of files and/or content. For example, expression section 1104 includes an emoji selectable control 1110, a symbol selectable control 1112, an emoticons selectable control 1114, and a GIF selectable control 1116. When a user selects a selectable control associated with a content category, additional selectable controls are displayed operable to insert content from the content category.

In the example, the device user selects GIF selectable control 1116. In response, sequential user display 106d is displayed with an expanded GIF section. In the example, recently used GIFs are displayed first.

FIG. 12 depicts a use case 1200, according to examples. FIG. 12 depicts another way that categories of files and/or content may be selected via sequential displays of user interface 106, labeled 106e and 106f. The display of user interface 106 is triggered and the device user enters “doc” into query field 108. Initial user interface 106e includes three categories: matching categories section 1202, matching documents section 1204, and matching expressions section 1206. Based on the query field text entered, “doc”, matching categories section 1202 displays a selectable control 1212 operable to display more files in the category, “Documents”.

Upon selecting selectable control 1212, a sequential user interface 106f is displayed. In examples, the text in query field 108 may be deleted in sequential user interface 106f, and the prompt, “Search documents” may be displayed in query field 108. One or more selectable controls associated with bookmarked and recently accessed files may be initially displayed in sequential user interface 106f. For example, one or more bookmarked files may be accessible via bookmarked file section 1208 (including selectable control 1207) and one or more recently accessed files may be accessible via recently accessed file section 1210. Upon entering one or more query terms for a document search into query field 108 of sequential user interface 106f, a user may receive one or more selectable controls to open documents targeted to the query terms.

In examples (not depicted), the query input may be further configured to initiate execution of a mathematical operation and display a result in response to determining that text including a math equation has been entered, for example via a short answer provider. A short answer provider may be configured to provide a natural-language response, usually including a few words to a sentence, when the text input matches a predetermined format. The predetermined format may be in the form of a regular expression. The predetermined format may be an input that includes certain keywords. An example of a short-answer provider is a program or module configured to provide conversions, such as currency conversions, temperature conversions (Celsius to Fahrenheit), a formula converter, and other such tools provided by search engines. The short answer provided by a short-answer provider may be content that is represented by a selectable option.

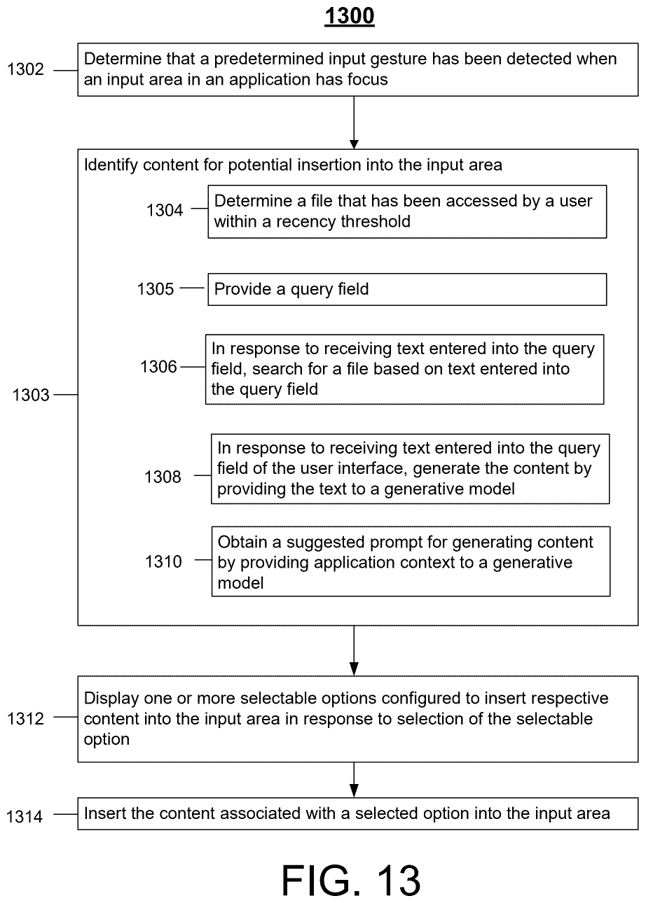

FIG. 13 depicts a block diagram of method 1300, according to an embodiment. Method 1300 may be operable to perform any combination of triggering and displaying user interface 106, displaying one or more selectable controls, and inserting selected content into input area 102 of an application 101. In examples, method 1300 may include any combination of steps 1302-1316.

Method 1300 may begin with step 1302. In step 1302, it may be determined that a predetermined input gesture has been detected when an input area in an application has focus. For example, keyboard key 202 may be pressed when input area 102 has focus, as described above.

Method 1300 may continue with step 1303. In step 1303 the system identifies content for potential insertion into the input area. Content for potential insertion is content suggested by the system in the user interface. The system may identify various content from various sources, as described with respect to FIGS. 1-12. Implementations may include identifying content from one or more of the example sources described herein. For example, method 1300 may include step 1304. In step 1304 it may be determined that a file that has been accessed by a user within a recency threshold. For example, FIG. 12 depicts recently accessed file section 1210. In examples, a file may be accessed within the last 3, 5, 7, 14, or 30 days. The file, e.g., a resource identifier for the file and/or content determined from the file may be content identified for potential inserting into the input area.

As another example, method 1300 may include step 1305. In step 1305 a query field is provided. For example, query field 108 may be displayed within user interface 106. The query field may be used to identify additional content for potential insertion into the input area. For example, in step 1306, a search may be initiated for a file(s). The search may be based on text entered into the query field. In examples, the search may be initiated in response to receiving text entered into a query input of the user interface 106. For example, when the text, “doc” is entered in query field 108, a search may be initiated to identify the documents associated with the selectable controls of matching documents section 1204, as described above with respect to FIG. 12.

In examples, with user permission, the search may be performed by querying an index of files available in an on-device directory. In examples, with user permission, the search may be performed by querying a cloud directory. In examples, with user permission, the search may be performed by searching a browser history or the URLs associated with open tabs. In examples, with user permission, the search may be performed by searching a social media content database, for example by using an application program interface call.

As another example, in step 1308, in response to receiving text entered into a query field of the user interface, the content may be generated based on text provided to the generative model. For example, the description around FIG. 9 describes generating the text (i.e., content) associated with selectable control 907 based on the text in input area 102, “Don't be worried.” In examples, user interface 106 may cause a prompt to be automatically generated based on context for input into a generative model. As another example, in step 1310, the system may obtain a suggested prompt for generating content. The suggested prompt may be generated by providing the application context to a generative model. The suggested prompt may then be associated with a selectable control that, when selected, sends the prompt to the generative model, which will then provide content for potential insertion into the input area. In some cases, application context may be provided with the prompt as input to the generative model.

Method 1300 may continue with step 1312. Step 1312 may include providing a selectable option configured to insert content related to a file into the input area in response to selection. In step 1312 may include displaying a selectable option that is configured to insert second content related to a second file into the input area in response to selection. For example, FIG. 12 depicts second selectable control 1207. In examples, a selectable option may be further be provided and configured to, in response to selection, perform a default operation of the predetermined input gesture. For example, user interface 106 may display file option 107a, file option 107b, default operation option 107c, etc., as described above.

Method 1300 may continue with step 1314. In step 1314 the content associated with a selected option may be inserted into the input area. For example, result 302 may be inserted into input area 102 as described with regards to FIG. 3 above.

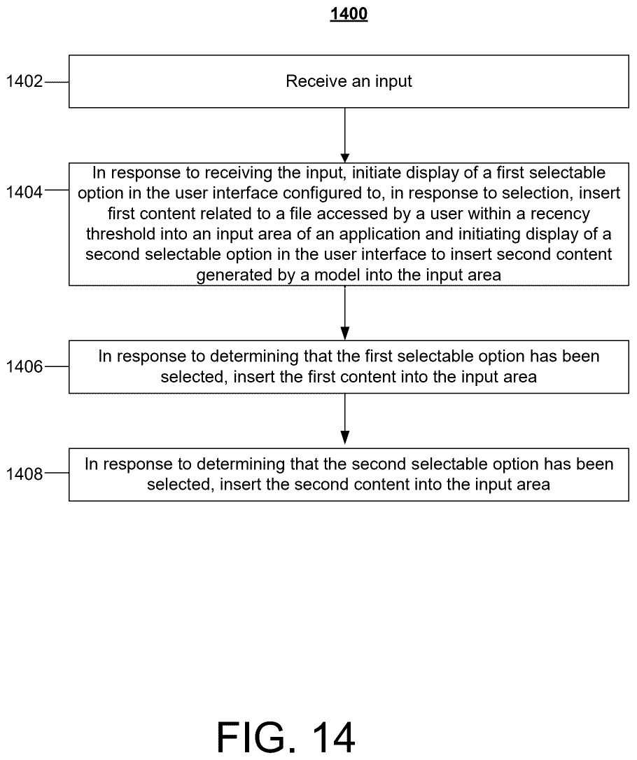

FIG. 14 depicts a block diagram of method 1400, according to an embodiment. Method 1400 may be operable to perform any combination of displaying user interface 106, displaying one or more selectable controls, and inserting selected content into input area 102 of an application 101. In examples, method 1400 may include any combination of steps 1402-1408.

Method 1400 may begin with step 1402. In step 1402, an input may be received. For example, a query may be received from a query input of a user interface. For example, a query may be received from query field 108 of user interface 106, as described above.

Method 1400 may continue with step 1404. In step 1404, in response to receiving the query, display of a first selectable option may be initiated in the user interface configured to, in response to selection, insert first content related to a file accessed by a user within a recency threshold into an input area of an application and initiating display of a second selectable option in the user interface to insert second content generated by a model into the input area. For example, FIG. 1 depicts user interface 106 with file option 107a, which is related to a file, and suggested prompt option 107d, which is related to content that can be generated with a model, as described above.

Method 1400 may continue with step 1406. In step 1406, in response to determining that the first selectable option has been selected, the first content may be inserted into the input area. For example, FIG. 3 depicts that content associated with file option 107a has been inserted into input area 102, as described above.

Method 1400 may continue with step 1408. In step 1408, in response to determining that the second selectable option has been selected, the second content may be inserted into the input area. For example, in FIG. 9 the content associated with selectable control 907 may be inserted into input area 102.

Further to the descriptions above, a user may be provided with controls allowing the user to make an election as to both if and when systems, programs, or features described herein may enable use of user data (e.g., information about websites a user has viewed, user files, calendar events, map data, messages sent, emoji used, etc.), and if any of that user data is sent to a server. In addition, certain data may be treated in one or more ways before it is stored or used, so that personally identifiable information is removed. For example, a user's geographic location may be generalized where location information is obtained (such as to a city, ZIP code, or state level), so that a particular location of a user cannot be determined. Thus, the user may have control over what user data is accessed, how that user data is used, and what user data is provided to the user.

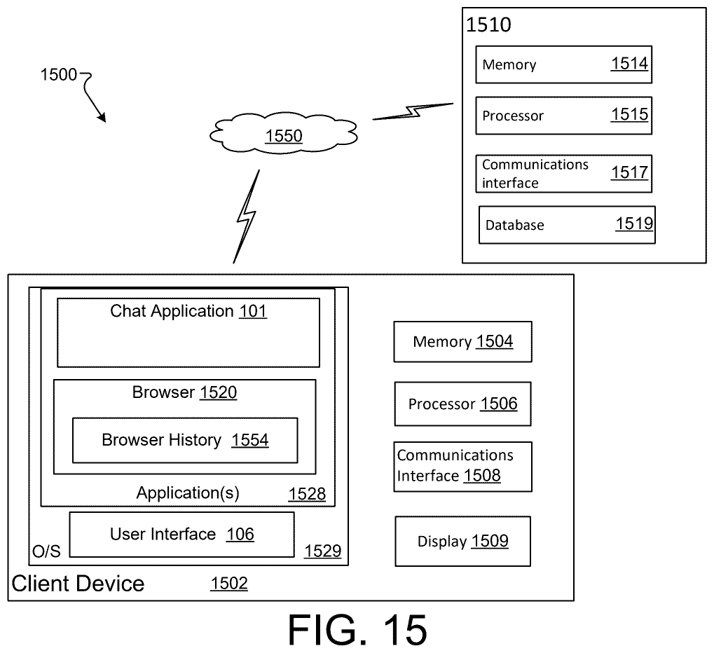

FIG. 15 depicts a block diagram of system 1500 that may execute the methods described herein, according to an example. System 1500 includes a client device 1502 and a server 1510 in communication via a network or the internet 1550.

Client device 1502 includes a non-transitory memory 1504, a processor 1506, and a communications interface 1508. Client device 1502 is in communication with a display 1509, which may be internal or external.

The client device 1502 may include an operating system 1529 upon which applications 1528 may execute. Applications 1528 represent specially programmed software configured to perform different functions, including creating, editing, and saving files with content. User interface 106 is a service that may also be provided by the operating system 1529.

One of the applications 1528 may include application 101. Another of the applications 1528 may be the browser 1520. The browser 1520 may be configured to display webpages, execute web applications, and the like in one or more windows or tabs. Browser 1520 further includes browser history 1554, as described above.

The client device 1502 may communicate with the server 1510 over a network. Server 1510 includes a non-transitory memory 1514, a processor 1515, a communications interface 1517, and a database 1519. The server 1510 may store in the memory 1514 instructions that, when executed by the processor 1515 cause the server 1510 to perform operations, such as working with the client device 1502 to generate information used to provide a comparison user interface.

The server 1510 may be a computing device or computing devices that take the form of a standard server, a group of such servers, or a rack server system. In some examples, the server 1510 may be a single system sharing components such as processors and memories. The network may include the Internet and/or other types of data networks, such as a local area network (LAN), a wide area network (WAN), a cellular network, satellite network, or other types of data networks.

In examples, database 1519 may include one or more databases. In examples, database 1519 may include an entity repository including a hierarchy of entity types. In examples, database 1519 may include predetermined entity information categories for various entity types. In examples, database 1519 may include information about entities, for example details about E-bikes.

In examples, any combination of steps from method 1300 and method 1400 may be executed on client device 1502 or server 1510.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device. Various implementations of the systems and techniques described here can be realized as and/or generally be referred to herein as a circuit, a module, a block, or a system that can combine software and hardware aspects. For example, a module may include the functions/acts/computer program instructions executing on a processor or some other programmable data processing apparatus.

Some of the above example implementations are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed but may also have additional steps not included in the figure. The processes may correspond to methods, functions, procedures, subroutines, subprograms, etc.

Methods discussed above, some of which are illustrated by the flow charts, may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a storage medium. A processor(s) may perform the necessary tasks.

Specific structural and functional details disclosed herein are merely representative for purposes of describing example implementations. Example implementations, however, have many alternate forms and should not be construed as limited to only the implementations set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example implementations. As used herein, the term and/or includes any and all combinations of one or more of the associated listed items.

The terminology used herein is for the purpose of describing particular implementations only and is not intended to be limiting of example implementations. As used herein, the singular forms a, an, and the are intended to include the plural forms as well, unless the context clearly indicates otherwise. It will be further understood that the terms comprises, comprising, includes and/or including, when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the figures. For example, two figures shown in succession may in fact be executed concurrently or may sometimes be executed in the reverse order, depending upon the functionality/acts involved.

Unless otherwise defined, all terms (including technical and scientific terms) used herein have the same meaning as commonly understood by one of ordinary skill in the art to which example implementations belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the above example implementations and corresponding detailed description are presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the above illustrative implementations, reference to acts and symbolic representations of operations (e.g., in the form of flowcharts) that may be implemented as program modules or functional processes include routines, programs, objects, components, data structures, etc., that perform particular tasks or implement particular abstract data types and may be described and/or implemented using existing hardware at existing structural elements. Such existing hardware may include one or more Central Processing Units (CPUs), Graphics Processing Units (GPUs), digital signal processors (DSPs), application-specific-integrated-circuits, field programmable gate arrays (FPGAs) computers or the like.

It should be borne in mind, however, that all of these and similar terms are to be associated with the appropriate physical quantities and are merely convenient labels applied to these quantities. Unless specifically stated otherwise, or as is apparent from the discussion, terms such as processing or computing or calculating or determining of displaying or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the example implementations are typically encoded on some form of non-transitory program storage medium or implemented over some type of transmission medium. The program storage medium may be magnetic (e.g., a floppy disk or a hard drive) or optical (e.g., a compact disk read only memory, or CD ROM), and may be read only or random access. Similarly, the transmission medium may be twisted wire pairs, coaxial cable, optical fiber, or some other suitable transmission medium known to the art. The example implementations are not limited by these aspects of any given implementation.

Lastly, it should also be noted that whilst the accompanying claims set out particular combinations of features described herein, the scope of the present disclosure is not limited to the particular combinations hereafter claimed, but instead extends to encompass any combination of features or implementations herein disclosed irrespective of whether or not that particular combination has been specifically enumerated in the accompanying claims at this time.

In some aspects, the techniques described herein relate to a method, further including: in response to determining that the first selectable option has been selected, inserting the content into the input area.

In some aspects, the techniques described herein relate to a method, wherein the file is further including: identifying the file using a context from the application.

In some aspects, the techniques described herein relate to a method, wherein the user interface includes a query field, and the method further includes: in response to receiving text entered into the query field, initiating a search for the file based on the text.

In some aspects, the techniques described herein relate to a method, wherein the user interface includes a query field, and the method further includes: in response to determining that text has been entered into the query field, generating the content based on the text.

In some aspects, the techniques described herein relate to a method, wherein the content is generated based on context from the application provided to a generative model.

In some aspects, the techniques described herein relate to a method, wherein the file associated with the first selectable option is identified based on being accessed by a user within a recency threshold.

In some aspects, the techniques described herein relate to a method, wherein the file is a first file, the content is first content, and the method further includes: displaying a third selectable option in the user interface configured to insert second content related to a second file into the input area in response to selection of the third selectable option, the first file and the second file having a same category.

In some aspects, the techniques described herein relate to a system, wherein the memory is further configured to: in response to determining that the first selectable option has been selected, insert the content into the input area.

In some aspects, the techniques described herein relate to a system, wherein the memory is further configured to: identify the content using context from the application.

In some aspects, the techniques described herein relate to a system, wherein the user interface includes a query field, and wherein the memory is further configured to: in response to receiving text entered into the query field, initiate a search for a file based on the text.

In some aspects, the techniques described herein relate to a system, wherein the user interface includes a query field, and wherein the memory is further configured to: in response to determining that text has been entered into the query field, generate the content based on the text.

In some aspects, the techniques described herein relate to a system, wherein the content is generated based on context from the application provided to a generative model.

In some aspects, the techniques described herein relate to a system, wherein a file is associated with the first selectable option and the file is identified based on being accessed by a user within a recency threshold.

In some aspects, the techniques described herein relate to a system, wherein a first file is associated with the first selectable option, the content is first content related to the first file, and the memory is further configured to: display a third selectable option in the user interface configured to insert second content related to a second file into the input area in response to selection of the third selectable option, the first file and the second file having a same category.

In some aspects, the techniques described herein relate to a method, wherein the first content is identified based on a context from the application.

In some aspects, the techniques described herein relate to a method, wherein the second content is generated based on a context from the application.

In some aspects, the techniques described herein relate to a method, wherein the second selectable option includes a prompt to generate generated content based on context from the application.

In some aspects, the techniques described herein relate to a method, wherein, in response to receiving the input, the user interface is further configured to initiate execution of a mathematical operation and display a result in response to determining that text including a math equation has been entered.

What is claimed is:

1. A method comprising:
determining that a predetermined input gesture has been detected when an input area in an application has focus; and
in response to determining that the predetermined input gesture has been detected when the input area has focus, initiating a display of a user interface including:
a first selectable option configured to insert content related to a file into the input area in response to selection, and
a second selectable option configured to, in response to selection, perform a default operation of the predetermined input gesture.

2. The method of claim 1, further comprising:
in response to determining that the first selectable option has been selected, inserting the content into the input area.

3. The method of claim 1, wherein the file is further comprising:
identifying the file using a context from the application.

4. The method of claim 1, wherein the user interface includes a query field, and the method further comprises:
in response to receiving text entered into the query field, initiating a search for the file based on the text.

5. The method of claim 1, wherein the user interface includes a query field, and the method further comprises:
in response to determining that text has been entered into the query field, generating the content based on the text.

6. The method of claim 1, wherein the content is generated based on context from the application provided to a generative model.

7. The method of claim 1, wherein the file associated with the first selectable option is identified based on being accessed by a user within a recency threshold.

8. The method of claim 1, wherein the file is a first file, the content is first content, and the method further comprises:
displaying a third selectable option in the user interface configured to insert second content related to a second file into the input area in response to selection of the third selectable option, the first file and the second file having a same category.

9. A system comprising:
a processor; and
a memory configured to:
detect a predetermined input gesture;
in response to detecting the predetermined input gesture, determining whether an input area in an application has focus;
in response to determining that an input area in an application has focus, initiating a display of a user interface including a first selectable option configured to insert content into the input area in response to selection, and
in response to determining that an input area in an application lacks focus, perform a default operation of the predetermined input gesture.

10. The system of claim 9, wherein the memory is further configured to:
in response to determining that the first selectable option has been selected, insert the content into the input area.

11. The system of claim 9, wherein the memory is further configured to:
identify the content using context from the application.

12. The system of claim 9, wherein the user interface includes a query field, and wherein the memory is further configured to:
in response to receiving text entered into the query field, initiate a search for a file based on the text.

13. The system of claim 9, wherein the user interface includes a query field, and wherein the memory is further configured to:
in response to determining that text has been entered into the query field, generate the content based on the text.

14. The system of claim 9, wherein the content is generated based on context from the application provided to a generative model.

15. The system of claim 9, wherein a file is associated with the first selectable option and the file is identified based on being accessed by a user within a recency threshold.

16. The system of claim 9, wherein a first file is associated with the first selectable option, the content is first content related to the first file, and the memory is further configured to:
display a third selectable option in the user interface configured to insert second content related to a second file into the input area in response to selection of the third selectable option, the first file and the second file having a same category.

17. A method comprising:
receiving an input entered in a user interface;
in response to receiving the input, initiating display of:
a first selectable option in the user interface configured to, in response to selection, insert first content related to a file accessed by a user within a time threshold into an input area of an application, and
a second selectable option in the user interface to insert second content generated by a model into the input area;
in response to determining that the first selectable option has been selected, inserting the first content into the input area; and
in response to determining that the second selectable option has been selected, inserting the second content into the input area.

18. The method of claim 17, wherein the first content is identified based on a context from the application.

19. The method of claim 17, wherein the second content is generated based on a context from the application.

20. The method of claim 17, wherein the second selectable option includes a prompt to generate generated content based on context from the application.

21. The method of claim 17, wherein, in response to receiving the input, the user interface is further configured to initiate execution of a mathematical operation and display a result in response to determining that text including a math equation has been entered.
